(19) United States
(12) Patent Application Publication
(10) Pub. No.: US 2020/0151666 A1
(43) Pub. Date: May 14, 2020

(54) SYSTEMS AND METHODS FOR DETERMINING SHIPPING TIMES AND PRESENTATION OF AVAILABLE SHIPMENT TIMES TO ONLINE USERS

(71) Applicant: Target Brands, Inc., Minneapolis, MN (US)

(72) Inventors: AMRUTA ABHAY PRAYAGI, Minneapolis, MN (US); RAJATH BASETTIHALLI RAGHAVENDRAPRASAD, Minneapolis, MN (US); VIPIN JAWARIA, Bengaluru (IN); MUKUND RAMAN, Bengaluru (IN); RAVIKUMAR BATCHU, Bengaluru (IN)

(21) Appl. No.: 16/681,590

(22) Filed: Nov. 12, 2019

Related U.S. Application Data
(60) Provisional application No. 62/760,787, filed on Nov. 13, 2018.

(51) Int. Cl. G06Q 10/08; G06Q 30/06

(52) U.S. Cl. CPC G06Q 10/08345; G06Q 30/0635

(57) ABSTRACT

Systems and methods for determining the availability of a shipping option on a per-item basis are described. A retail user interface is provided from an online retailer, the retail user interface includes a plurality of selectable items available for delivery to a customer. Shipping options are offered to the customer on a per-item basis dependent on the actual transit time from a retail location to a destination location.

### CROSS-REFERENCE TO RELATED APPLICATIONS

This application claims priority to U.S. Provisional Application Ser. No. 62/760,787 filed on Nov. 13, 2018, the entire disclosure of which is hereby expressly incorporated herein by reference.

### TECHNICAL FIELD

The present disclosure is directed to systems and methods for determining the availability of a shipping option when ordering merchandise online. More particularly, the present disclosure describes a method for determining an actual transit time from a retail location to a destination location.

### BACKGROUND

Customers are increasingly ordering merchandise online. The merchant website allows the customers to view the item and information about the item, such as a picture of the item, a description of the item, the price of the item, and options to ship the item to a destination address. Often, a general shipping time frame is presented to the customer with the product, but the retailer cannot accurately predict shipping times. Therefore, merchants offer a generic shipping time frame, such as from 2-14 days.

For various reasons, merchants often have difficulty accurately predicting delivery times. This prevents merchants from offering shipping times within a predetermined and specific time frame. It can further prevent merchants from offering quicker shipping times for fear of not delivering within the promised quicker shipping time.

Customers also often desire free shipping and may tailor shopping behavior to purchase products with free shipping offered. Merchants bear the cost of shipping when offering free shipping to customers, but still want to keep costs low. Accordingly, it is desirable to determine whether or not to offer different shipping speeds and whether or not to charge the customers for the different shipping speeds.

### SUMMARY

In general, systems and methods for determining the availability of a shipping option on a per-item basis are described. The systems and methods described herein determine an actual transit time on a per-item basis to determine if a predetermined shipping option is available. Various aspects are described in this disclosure, which include, but are not limited to, the following aspects.

In a first aspect, a method for determining an availability of a shipping option comprises the following. A retail user interface is provided from an online retailer, the retail user interface includes a plurality of selectable items available for delivery to a customer. A software tool implemented on a computing system receives inputs related to an order comprising an inventory item selected from among the plurality of selectable items. Individually, for each of the inventory items, one or more retail locations is determined from which the inventory item can be delivered to a destination location within a predetermined time frame under default delivery conditions. An actual transit time is determined from each of the one or more retail locations to the destination location for the inventory item. Based on the actual transit time from any of the one or more retail locations being below the predetermined time frame, an item description web interface is automatically provided that includes a shipping option for delivery of the item within the predetermined time frame.

In another aspect, a system for facilitating online order fulfillment from retail locations is provided. The system includes a computing system comprising at least one processor communicatively connected to a memory, the memory storing computer-executable instructions comprising a software tool which, when executed, causes the computing system to do the following. A retail user interface is provided from an online retailer, the retail user interface includes a plurality of selectable items available for delivery to a customer. A software tool implemented on a computing system receives inputs related to an order comprising an inventory item selected from among the plurality of selectable items. Individually, for each of the inventory items, one or more retail locations is determined from which the inventory item can be delivered to a destination location within a predetermined time frame under default delivery conditions. An actual transit time is determined from each of the one or more retail locations to the destination location for the inventory item. Based on the actual transit time from any of the one or more retail locations being below the predetermined time frame, an item description web interface is automatically provided that includes a shipping option for delivery of the item within the predetermined time frame.

In yet another aspect, a retail web server configured to facilitate online orders fulfilled from retail locations is provided. The system includes a computing system comprising at least one processor communicatively connected to a memory, the memory storing computer-executable instructions comprising a software tool which, when executed, causes the computing system to do the following. A retail user interface from an online retailer is provided, the retail user interface includes a plurality of selectable items available for delivery to a customer. A selection of an item is received from a user device. The selection of the item and a delivery location are transmitted to a supply chain fulfillment server. An indication of whether a shipping option for delivery of the item within the predetermined time frame is available based on the current shipping conditions is received from the supply chain fulfillment server. Based on the shipping option being available, an item user interface is automatically provided to the user device, the item user interface includes an identification of the shipping option. Based on the shipping option not being available, an item user interface is automatically provided to the user device, the item user interface not including the identification of the shipping option.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an example supply chain for a retail enterprise.

FIG. 2 illustrates an example block diagram of a computing system usable in the shipping option availability system.

FIG. 3 illustrates an example block diagram of a computing system usable by the delivery time management system of FIG. 2.

FIG. 4 illustrates an example block diagram of a computing system.

FIG. 5 is a flow chart of an example method of determining what shipping options to offer.

FIG. 6 is a flow chart of an example method of determining what shipping options to offer on a retail website user interface.

FIGS. 7a-7b each show an example user interface of a retail website on a computing system.

FIG. 8 is an example user interface of a retail website in an application-based system.

Like numbers used in the figures refer to like components. However, it will be understood that the use of a number to refer to a component in a given figure is not intended to limit the component in another figure labeled with the same number.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

In general, the present disclosure describes a system and method for determining an availability of a shipping option from an online retailer. The systems and methods described herein determine an actual transit time on a per-item basis to determine if a predetermined shipping option is available.

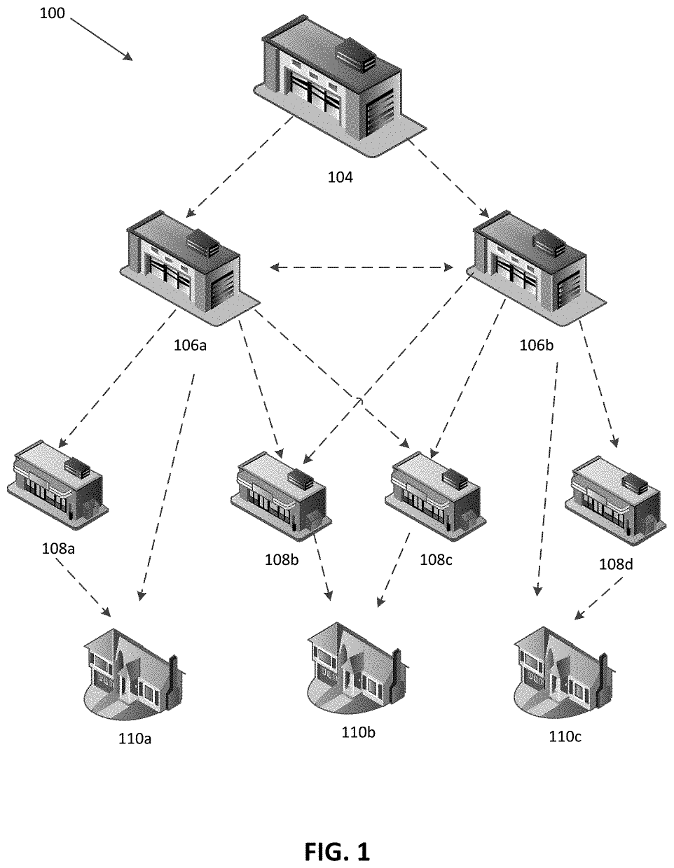

FIG. 1 illustrates a schematic diagram 100 of an example supply chain for a retail enterprise. A retail enterprise may be an online retailer or a brick-and-mortar retailer with an online presence. The diagram 100 illustrates the flow of inventory from a node to a destination location 110. The inventory moves through various nodes to arrive at the customer. In this example, the nodes include a receive center 104, two flow centers 106a, 106b, four retail stores 108a, 108b, 108c, 108d, and three destination locations 110a, 110b, 110c. In practice, the supply chain could include many more nodes in different proportions. In some embodiments, there are not separate receive centers and flow centers. Instead, there may be one type of warehouse or distribution center for holding inventory before distributing to stores and customers. Arrows in the diagram 100 indicate movement of inventory. Inventory will typically flow downward through the supply chain, but in some instances, inventory may move between flow centers 106 or between retail stores 108. In some embodiments, inventory may even move from a flow center 106 to a receive center 104 or from a retail store 108 to a flow center 106. Once at the receive center 104, the products are prepared for transportation to one or more flow centers 106 or destination locations 110.

A variety of products are prepared for shipment to one or more flow centers 106. The flow centers 106 are typically positioned to enable quick shipment to one or more retail stores 108. Each flow center 106 may supply inventory to multiple retail stores 108. In some instances, more than one flow center 106 will send inventory to a retail store 108. For example, in FIG. 1, flow center 106a distributes inventory to stores 108a, 108b, and 108c. Flow center 106b distributes to stores 108b, 108c, and 108d. In the example of FIG. 1, products are shipped directly from flow center 106a to a destination location 110a and from flow center 106b to destination location 110c.

Depending on the location of a customer ordering products online, the shipments of products could come from one or more retail stores 108, or flow centers 106. For instance, the customer could receive shipments of products from either store 108b or store 108c, or both (in the instance of a multi-item purchase) at the destination location 110b.

It is in this general supply chain retail environment that the following systems and methods operate. While the systems and methods are described in a retail environment having brick-and-mortar stores as well as online sales, additional applications are possible. For example, the systems and methods could operate in a supply chain of warehouses that only distribute products to customers in fulfillment of online orders. Regardless of the application, the systems and methods described herein provide the most benefit when determining when to offer shipping options in a predetermined time frame.

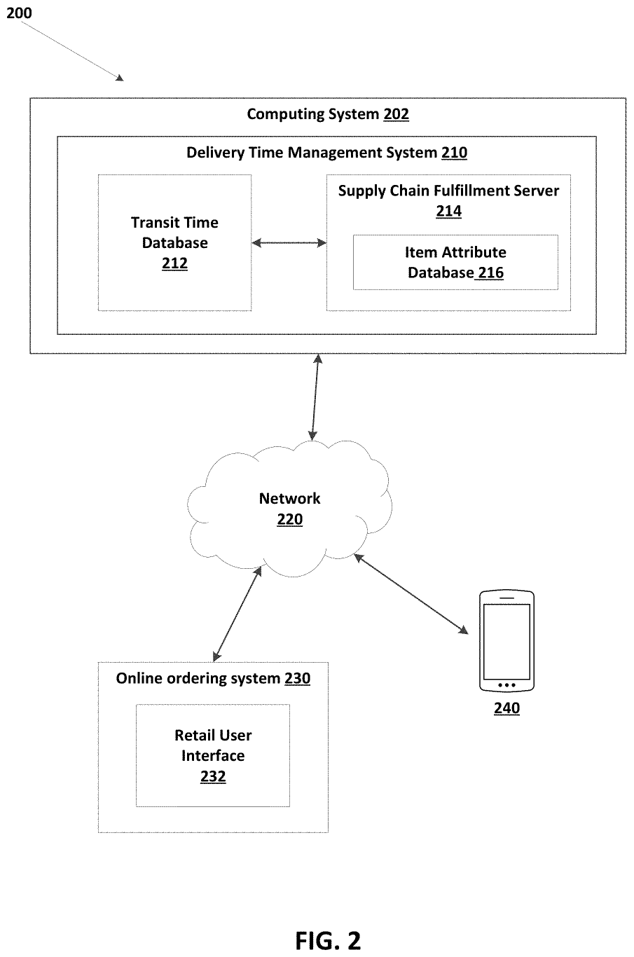

FIG. 2 illustrates a schematic diagram of an overall system 200 for which shipping options are presented to a customer on a retail web interface. In an embodiment, a predetermined shipping speed is used as a threshold. For example, many customers desire two-day shipping, so two days is used as a threshold. The computing system 202 determines the actual shipping speed for an item, and if the actual shipping speed is less than the threshold, then the predetermined shipping speed is offered to the customer. In an example, a customer selects an item, and the delivery time management system 210 determines if that item can be delivered within a predetermined time frame (in this example, two days). If the item can be shipped within two days, then a two-day shipping option is presented. Whether or not a shipping option is offered is dependent not only on the predicted transit time, but also whether or not it is economical for the retailer to ship the item at that speed. Economic viability of shipping speeds may be used by the retailer to determine if complimentary shipping should be offered.

Components of the overall system 200 includes a computing system 202, a network 220, and an online ordering system 230. Together, the components determine which shipping options are presented on the retail web user interface, so the customer is aware of shipping options before purchasing an item.

Components of the computing system 202 includes a delivery time management system 210, which includes a transit time database 212 and a supply chain fulfillment server 214. The transit time database 212 and the supply chain fulfillment server 214 operate to determine where an inventory item is located, what the transit time is to transport the item from a retail location to a destination location 110, and to determine if the inventory item can be delivered to the destination location 110 within the predetermined time frame.

The transit time database 212 is useful in determining what shipping options should be presented to a customer on a per-item basis. In an embodiment, the quickest, but most economical shipping option is presented. For example, if the predicted transit time enables an item to be shipped within one day, but the costs of shipping that quickly are too high, then one-day shipping is not offered. In another embodiment, the quickest shipping option is offered. In yet another embodiment, the quickest shipping option is presented, but the shipping option may include additional costs to the customer.

The transit time database 212 predicts the transit time of an item from a retail location to a destination location 110. The transit time database 212 balances predicted transit times with current transit times determined by current events. Predicted transit times may be determined from past deliveries and a standard delivery time in an ideal environment. An ideal environment does not have any mitigating factors, and represents the quickest time an item could be delivered. Mitigating factors include things that affect transit times, such as weather conditions, natural disasters, road construction, and traffic delays. For example, a weather event such as a flood may drastically affect transit times.

The supply chain fulfillment server 214 accesses information about the selected item from an item attribute database 216. Item attributes include all information about the item, including, but not limited to, information that affects transit time. Item attributes include features such as whether particular items need to be temperature controlled (e.g., freezer), whether the items contain hazardous materials and require special handling, whether the items are flammable, the items' dimensions and weights, and whether the items are bulky, etc.

The supply chain fulfillment server 214 accesses information in the item attribute database 216 to select proper transportation equipment for conveying the required items to the destination location 110. Transportation equipment is selected based on the attributes of the items as well as cost, availability, etc. The system 202 schedules deliveries of shipments and executes delivery services tailored to each node and destination location 110. To schedule the transportation of inventory, the system 202 selects a carrier service based on the expected transit times and transit expenses.

The delivery time management system 210 also determines which types of transportation equipment are needed to transport the ordered items from the vendor to the warehouse. For example, the equipment may need to handle hazardous items or temperature sensitive items. In addition, the equipment must be sized appropriately to handle the size of the item and the number of items that are delivered. In some instances, the equipment may be scheduled for more than one pick-up, so the equipment must be compatible with all of the items that it is scheduled to pick up.

An item attribute database 216 stores information about attributes of the items or products that are being shipped and sold within the supply chain. Attributes of the products include weight, volume, units, and whether particular handling is required. Special handling may be required for items that require refrigeration, items that are flammable, or other hazardous materials in items. The delivery time management system 210 relies on information in the item attribute database 216 to select equipment for transporting items.

The transit time database 212 stores information about transportation equipment, transit times, delivery schedules, personnel, and outside contractors. The transportation equipment includes trucks, trailers, and other delivery equipment. Personnel information includes data for available personnel to staff the transportation equipment, cost of using internal personnel, and cost of hiring outside contractors.

The transit time database 212 also stores information related to transit times for movement of an item from a plurality of retail locations to a destination location 110. Transit times are determinate based on the item characteristics, as some items may need additional lead-time for transport (i.e., hazardous or flammable materials).

All the factors used by the transit time database 212 are used to determine the economic feasibility of specified delivery times. A delivery option will not be presented for an item if the shipping costs to deliver within a predetermined time frame are significantly higher than shipping costs to deliver the item within a different time frame. Costs to deliver an item to different destination locations 110 differ. Therefore, the same item may be presented with different delivery options to customers who have different destination locations 110.

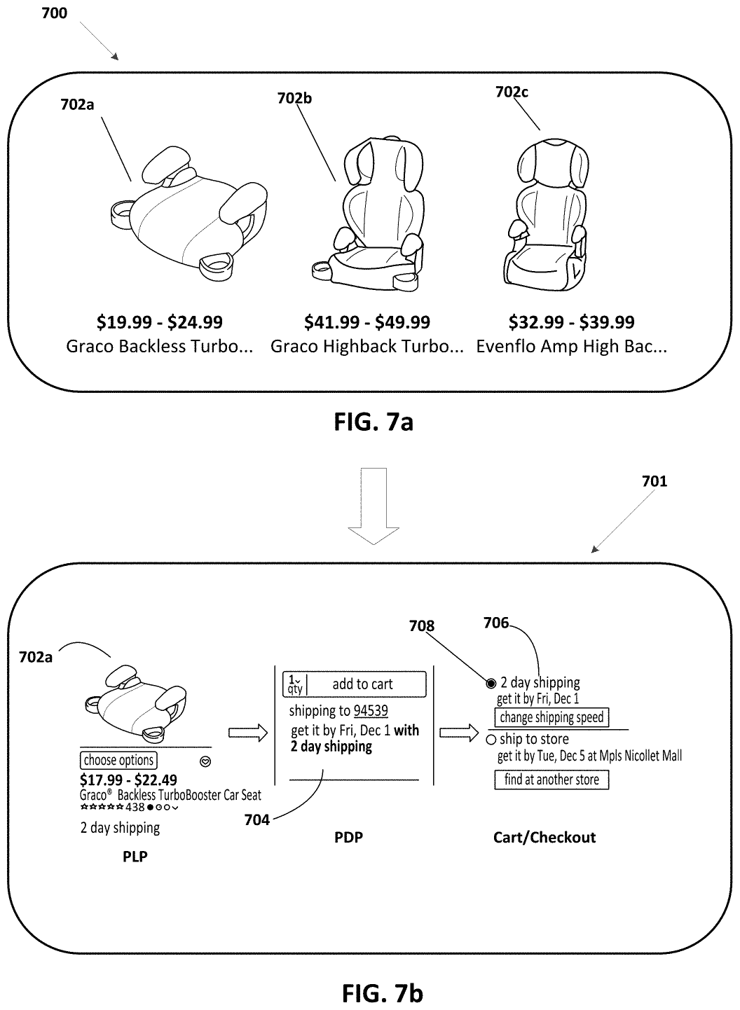

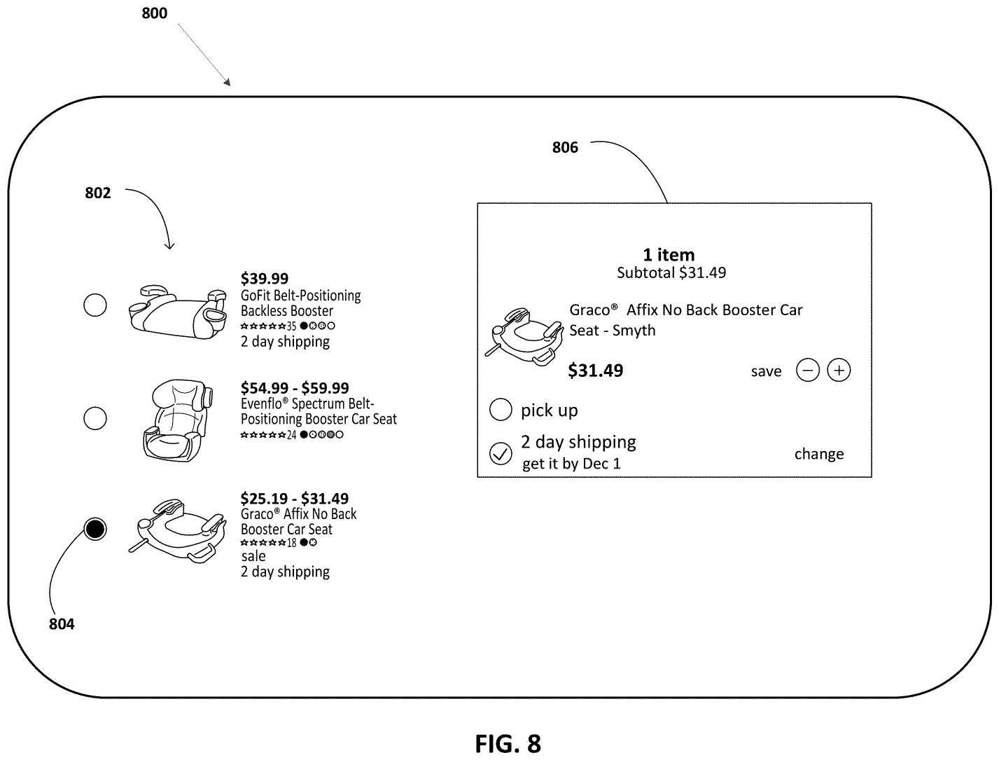

The online ordering system 230 is connected to the computing system 202 through a network 220. The online ordering system 230 comprises a retail user interface 232, which a customer accesses through a computing device 240. The online ordering system 230 includes a retail user interface 232, which is described in further detail with regard to FIGS. 7-8.

The online ordering system 230 receives instructions from the delivery time management system 210 to determine what shipping speeds to offer for which inventory items to a customer. Then, the online ordering system 230 displays on the retail user interface 232, the available shipping options, which are viewable to the customer on the computing device 240.

In the embodiment shown, the online ordering system 230 receives information from a customer including a destination location 110 and a selected item. The online ordering system 230 then receives shipping options for the selected item and displays them on the retail user interface 232 for the customer to see.

In some embodiments, the delivery time management system 210 communicates with the online ordering system 230 through a network 220. The network 220 can be any of a variety of types of public or private communications networks, such as the Internet. The computing device 240 can be any network-connected device including desktop computers, laptop computers, tablet computing devices, smartphones, and other devices capable of connecting to the Internet through wireless or wired connections.

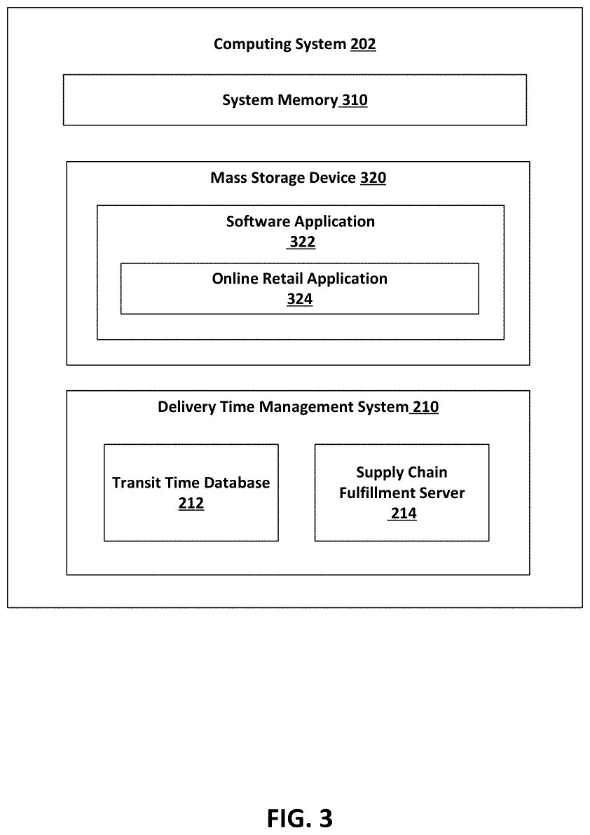

Now referring to FIG. 3, an example block diagram of a simplified computing system 202 that is useable by the retailer to implement aspects of the delivery time management system 210 of FIG. 2 is shown. In the embodiment shown, the computing system 202 includes a system memory 310, a mass storage device 320, and a delivery time management system 210.

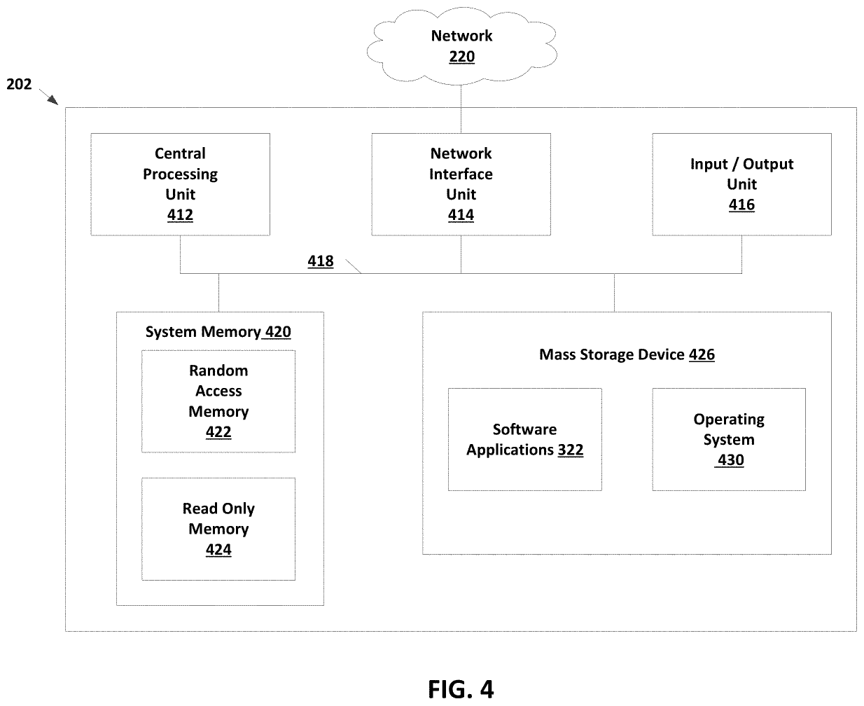

The system memory 310 is described in more detail below in regard to FIG. 4.

According to various embodiments of the invention, the computing system 202 may operate in a networked environment using logical connections to remote network devices through a network 220, such as a wireless network, the Internet, or another type of network, as shown in FIG. 2.

The mass storage device 320 of the computing system 202 can store a software application 322. The software application 322 includes an online retail application 324. The online retail application 324 functions similar to a POS application used in in-store retail locations. The online retail application 324 operates to display a catalog of items online to a customer and further, to execute online sales. The online retail application 324 coordinates with the online ordering system 230, which coordinates with the delivery time management system 210 to display shipping options to the customer.

The delivery time management system 210 comprises a transit time database 212 and supply chain fulfillment server 214, both of which are described above in further detail. For brevity, details of the transit time database 212 and supply chain fulfillment server 214 are omitted.

Referring now to FIG. 4, an example block diagram of a computing system 202 is shown that is useable to implement aspects of the delivery time management system 210 of FIG. 2 and software application 322 of FIG. 3. In the embodiment shown, the computing system 202 includes at least one central processing unit (“CPU”) 412, a system memory 420, and a system bus 418 that couples the system memory 420 to the CPU 412. The system memory 420 includes a random access memory (“RAM”) 422 and a read-only memory (“ROM”) 424. A basic input/output system that contains the basic routines that help to transfer information between elements within the computing system 202, such as during startup, is stored in the ROM 424. The computing system 202 further includes a mass storage device 426. The mass storage device 426 is able to store software instructions and data.

The mass storage device 426 is connected to the CPU 412 through a mass storage controller (not shown) connected to the system bus 418. The mass storage device 426 and its associated computer-readable storage media provide non-volatile, non-transitory data storage for the computing system 202. Although the description of computer-readable storage media contained herein refers to a mass storage device 426, such as a hard disk or solid state disk, it should be appreciated by those skilled in the art that computer-readable data storage media can include any available tangible, physical device or article of manufacture from which the CPU 412 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 202.

According to various embodiments of the invention, the computing system 202 may operate in a networked environment using logical connections to remote network devices through a network 220, such as a wireless network, the Internet, or another type of network. The computing system 202 may connect to the network 220 through a network interface unit 414 connected to the system bus 418. It should be appreciated that the network interface unit 414 may also be utilized to connect to other types of networks and remote computing systems. The computing system 202 also includes an input/output unit 416 for receiving and processing input from a number of other devices, including a touch user interface display screen, or another type of input device. Similarly, the input/output unit 416 may provide output to a touch user interface display screen or other type of output device.

As mentioned briefly above, the mass storage device 426 and the RAM 422 of the computing system 202 can store software instructions and data. The software instructions include an operating system 430 suitable for controlling the operation of the computing system 202. The mass storage device 426 and/or the RAM 422 also store software instructions, that when executed by the CPU 412, cause the computing system 202 to provide the functionality discussed in this document. For example, the mass storage device 426 and/or the RAM 422 can store software instructions that, when executed by the CPU 412, cause the computing system 202 to receive and analyze inventory and demand data.

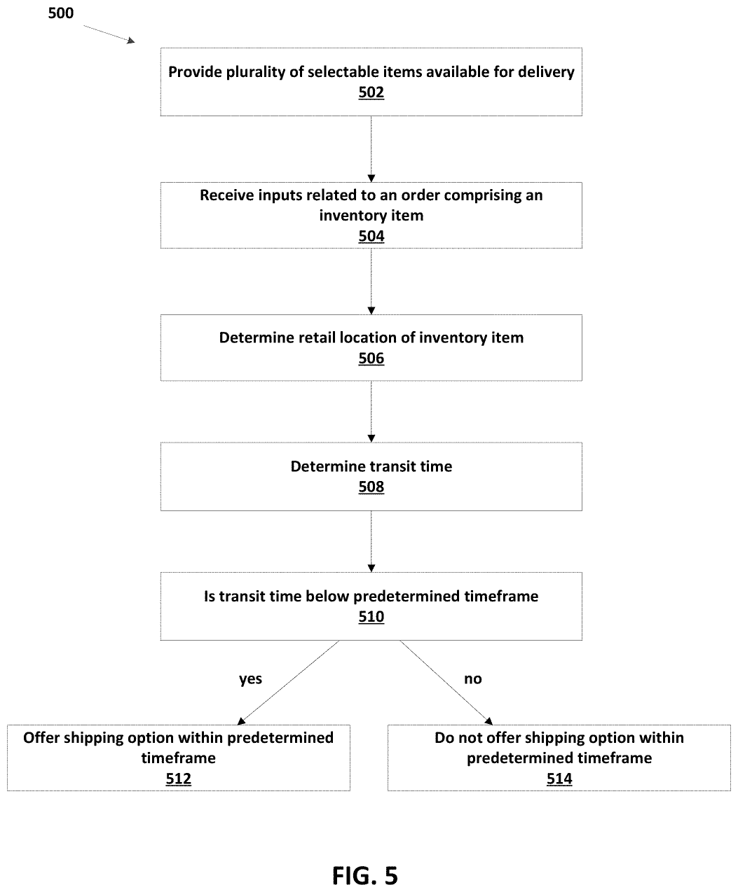

FIG. 5 displays a flow diagram of a method 500 of determining an availability of a shipping option in accordance with the present disclosure. In particular, the method 500 can determine when to provide an item description web interface that includes a shipping option for delivery of the item within a predetermined time frame. In some embodiments, the method 500 is performed by the delivery time management system 210 of FIG. 2. In other embodiments, the method 500 is performed using a software tool such as an online retail application 324 of FIG. 3.

The method 500 is performed to provide shipping options to a customer when the customer is browsing an online retailer user interface 232. Shipping options are displayed to a customer when they are viewing item details, assuming that the customer has provided a destination location 110 for shipment of the item(s). Shipping options are provided on a per-item basis, specific to the destination location 110.

Generally, shipping options are determined by first identifying a threshold shipping time frame, for example two days. The threshold shipping time frame is also referred to as a predetermined time frame. The shipping time frame may represent a time frame at which the retailer offers complimentary shipping. Then, the transit time is determined and if it is below the threshold, the predetermined time frame is presented to the customer as a shipping option. The method 500 is described more specifically below.

At operation 502, a plurality of selectable items available for delivery are provided. The plurality of items are provided to a customer on a web user interface of the retailer's website. The retailer may be an online retailer or the retailer may be a retailer with a brick-and-mortar store with an online presence.

The web interface includes information relating to the item(s), such as the name of the item, an item image, an item description, an item rating, and a price. In some embodiments, if the customer has not entered a destination location 110, shipping information is not available to the customer. When shipping information is not available, the web user interface requests a destination location 110 for delivery from the customer. Once a destination location 110 is received, the web user interface is capable of displaying shipping options, as described in detail below.

In another embodiment, the customer has previously presented a destination location 110, so shipping information is automatically provided for each inventory item relative to the destination location 110. The destination location 110 may be provided by the customer as a one-time entry (as described above) or the customer may have used a login that has a destination location 110 stored. Still further, the web interface may utilize cookies to determine where the customer is located and assumes the current location of the customer is the destination location 110.

At operation 504, inputs are received at a software tool, such as the online ordering system 230 of FIG. 2. The inputs include a customer selecting an inventory item from a list of a plurality of inventory items to view item details. After a customer has selected an inventory item to view more details, the method 500 proceeds to ultimately display available shipping options (operation 512 and operation 514). Inputs also include a destination location 110 for shipping the item.

In another embodiment, the inputs are related to an online order that comprises an order of at least one inventory item. For example, the input is received when a customer has placed the inventory item in an online shopping cart. After a customer has placed the inventory item in the online shopping cart, the method 500 proceeds to ultimately display available shipping options. In an example embodiment, each inventory item of the order is processed separately when determining shipping options. In another embodiment, inventory items are grouped based on a set of predetermined factors, such as where the inventory items are located, or when shipping options are determined.

At operation 506, at least one retail location of each inventory item is determined. As described above, the retail location of an inventory item is determined when the customer has selected the inventory item to view additional details. The inventory item may be located at one or more retail locations that is capable of delivering the item to the destination location 110 within a predetermined time frame under default delivery conditions. In an embodiment, the retail location that provides the most economical shipping option is selected as the retail location. In another embodiment, the retail location that provides the quickest shipping option is selected.

Default delivery conditions are delivery conditions that do not include unexpected delays, such as unexpected weather conditions, road closures, or other similar acts of God. Default delivery conditions represent the quickest transit time an item can be delivered to the destination location 110. Default delivery conditions also represent economically feasible transit times.

In another embodiment, after an order for an inventory item is received, at least one location where the inventory item is located is determined. The inventory item may be located at one or more retail locations that is capable of delivering the item to the destination location 110 within a predetermined time frame under default delivery conditions. In an embodiment, the retail location is determined on an individual basis for each inventory item. Therefore, an order may be split into multiple components, depending on the location of the selected retail location. Alternatively, the order may not be split into multiple components if more than one inventory item is located at the same retail location.

Retail locations that have the inventory items in stock are first identified. In a first embodiment, when multiple retail locations are identified, the retail location closest to the destination location 110 is selected. In another embodiment, the retail location with the most economical shipping costs is selected, even if the retail location is further away from the destination location 110 than a different retail location. Still further, the retail location with the most reliable shipping times may be selected. The most economical shipping costs is a factor because many customers desire free shipping, without causing the cost of the item to raise significantly to cover the cost of shipping the item.

Retail locations may be any node within a supply chain of a retail enterprise as shown in FIG. 1. For example, nodes may be a receiving center, flow center, or retail store (brick-and-mortar location).

Once the retail location of the item is established, the supply chain fulfillment server 214 will place the inventory item on hold so the inventory location does not change if/when the item is added to the cart. This ensures that the inventory item is still in stock at the retail location from which a shipping time frame was determined and displayed to the customer. Then, the delivery time presented to the customer remains a delivery time that can actually be met.

At operation 508, the transit time from each of the one or more retail locations to the destination location 110 for each inventory item is determined. In some embodiments, the operation 508 is performed by the transit time database 212 of FIG. 2. In some instances, the operation 508 is performed using a software tool such as a navigation software tool.

The transit time database 212 determines the time it takes to deliver an inventory item from a selected retail location to the destination location 110. Actual transit time is determined in view of mitigating factors, for example, weather conditions, natural disasters, road constructions/closures, and traffic delays. Further, transit time may take into consideration factors such as whether particular items need to be temperature controlled (e.g., freezer), whether the items contain hazardous materials and require special handling, whether the items are flammable, the items' dimensions and weights, or whether the items are bulky, etc. Transit times included in the transit time database 212 include both current and anticipated future transit times.

Transit times may be measured in hours, or more optimally, days. Days may be calculated numerous ways. In a first example, the day the order is placed is not calculated as one of the shipping days. In another example, if the order was placed after the close of business (for example, after 5:00 pm), the day the order is placed is not calculated as one of the shipping days. In yet another example, if the order was placed before the close of business (for example, before 5:00 pm), the day the order is placed is calculated as one of the shipping days.

For example, an order placed on a Monday will be delivered by the end of day Tuesday with one-day shipping. In some embodiments, only business days are counted as days for shipping times. For example, Saturdays and Sundays (or other recognized holidays) are not counted as days when determining transit times. Further, orders placed after a cut-off time on a day may be counted as an order placed on the following day. For example, an order placed on a Monday at 9:00 pm may be counted as an order placed on Tuesday, so one-day shipping would guarantee delivery by the end of day Wednesday.

At operation 510, the delivery time management system 210 determines whether the transit time provided by the transit time database 212 is below a predetermined time frame. If the transit time provided is below the predetermined time frame, then the method moves to operation 512. While, if the transit time provided is at or above the predetermined time frame, then the method moves to operation 514.

At operation 512, an item description web interface is provided to the customer that includes a shipping option for delivery of the item within the predetermined time frame. A predetermined time frame is a pre-selected time frame at which to offer shipping. For example, a predetermined time frame may be selected as two days or less. If the transit time database 212 determines that the item can be delivered to the destination location 110 in 36 hours, then a two-day delivery option is provided to the customer.

At operation 514, an item description web interface is provided to the customer that does not include a shipping option for delivery of the item within the predetermined time frame. For example, the predetermined time frame may be selected as two days or less. If the transit time database 212 determines that the item can be delivered to the destination location 110 in, e.g., at the earliest four days, then a two-day delivery option is not provided to the customer.

At a next step (not shown), a second predetermined time frame is selected. In an example, the second predetermined time frame is greater than two days. If the transit time database 212 determines that the item cannot be delivered to the destination location 110 within two days, then the second predetermined time frame delivery option is provided to the customer. The second predetermined time frame may be five to seven days. The shipping option presented on the user interface may be the estimated transit time.

The shipping options dynamically change depending on the destination location 110 and the inventory item. Different inventory items may be available to ship within the time frame to different destination locations 110. Further, as inventory moves within a supply chain, shipping options to a destination location 110 may change.

It should be noted that offering a shipping option within a predetermined time frame assumes that offering that shipping speed to the customer free of charge is economical. Shipping options are not limited to only these free options. Expedited shipping options may still be presented to customers for an additional cost. Expedited shipping options are defined as shipping options that may be offered to the customer even if the transit time does not meet the predetermined threshold shipping time frame. Alternatively, expedited shipping options may refer to two-day shipping.

As a particular illustration of the above, it is noted that traditional transit time models use simple calculations that do not include determining transit times in view of mitigating factors.

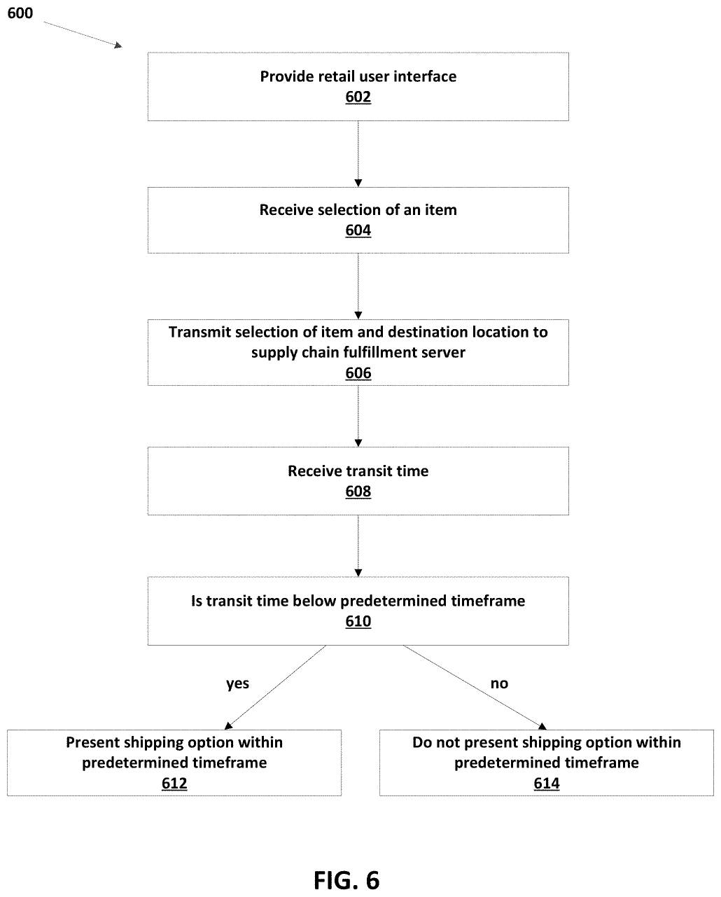

FIG. 6 illustrates an example method 600 to provide shipping options to a customer when the customer is browsing an online retailer user interface 232. In an embodiment, the method 600 is performed by a computing system 202 that has a software tool to execute the following steps.

At step 602, a retail user interface 232 is provided. For example, in use, a customer navigates to a retailer's website where a plurality of items are offered for sale. The website may be an online only retailer, or may be a retailer with a brick-and-mortar store that also sells merchandise online. The retail user interface 232 includes information relating to the items, such as the name of the item, an item image, an item description, an item rating, and a price. In some embodiments, if the customer has not entered a destination location 110, shipping information is not available to the customer. When shipping information is not available, the web user interface requests a destination location 110 for shipment from the customer. Once a destination location 110 is received, the web user interface displays shipping options.

In another embodiment, the customer has previously provided a destination location 110, so shipping information is automatically provided for each inventory item relative to the destination location 110. The destination location 110 may be provided by the customer as a one-time entry (as described above) or the customer may have used a login that has a destination location 110 stored. Still further, the web interface may utilize cookies to determine where the customer is located and assumes the location of the customer is the destination location 110.

At step 604, selection of an item is received. The selection of an item may include a customer selecting an inventory item from a list of a plurality of inventory items to view item details. Alternatively, the selection of an item may include a customer placing the inventory item in an online shopping cart. Either selection process is an indication to the system 202 that a customer is interested in the inventory item, and shipping options need to be displayed.

At step 606, the selection of the item and the destination location 110 are transmitted to the supply chain fulfillment server 214. The supply chain fulfillment server 214 determines which retail locations the inventory item is located at and transmits that information to the transit time database 212. The supply chain fulfillment server 214 also accesses information about the item, such as item attributes that may affect shipping. For example, if an item requires special handling, the supply chain fulfillment server 214 transmits this information to the transit time database 212.

At step 608, the transit time for the item is received. The transit time database 212 determines the transit time from a retail location to the destination location 110. The transit time database 212 calculates the time it takes to deliver the item from a retail location selected from a plurality of retail locations to the destination location 110. The transit time database 212 also determines which retail location provides the quickest and most economical shipping option.

The transit time database 212 also considers mitigating factors that can affect transit time, such as weather conditions, natural disasters, road construction, and traffic delays. In an embodiment, the transit time database 212 determines which transit time is used to compare to the predetermined time frame. In an alternative embodiment, the transit time database 212 sends one or more transit times to the supply chain fulfillment server 214, which determines which shipping time frame to compare to the predetermined time frame.

At step 610, the delivery time management system 210 determines whether the transit time provided by the transit time database 212 is below a predetermined time frame. If the transit time provided is below the predetermined time frame, then the method moves to operation 612. While, if the transit time provided is at or above the predetermined time frame, then the method moves to operation 614.

At operation 612, an item description web interface is provided to the customer that includes a shipping option for delivery of the item within the predetermined time frame. A predetermined time frame is a pre-selected time frame at which to offer shipping. For example, a predetermined time frame may be selected as two days or less. If the transit time database 212 determines that the item can be delivered to the destination location 110 in 36 hours, then a two-day delivery option is provided to the customer.

At operation 614, an item description web interface is provided to the customer that does not include a shipping option for delivery of the item within the predetermined time frame. For example, the predetermined time frame may be selected as two days or less. If the transit time database 212 determines that the item can be delivered to the destination location 110 in four days, then a two-day delivery option is not provided to the customer.

At an optional next step (not shown), a second predetermined time frame is selected. In an example, the second predetermined time frame is greater than two days. If the transit time database 212 determines that the item cannot be delivered to the destination location 110 within two days, then the second predetermined time frame delivery option is provided to the customer. The second predetermined time frame may be five to seven days. The shipping option presented on the user interface may be the estimated transit time.

FIG. 7a illustrates an example user interface 700 displaying a plurality of inventory items 702a, 702b, 702c for sale. The inventory items 702 are shown without shipping options. In an embodiment, a customer navigates to the user interface 700 and is presented with the plurality of items 702. Once a user selects an item to view more information, the user interface 701 of FIG. 7b is displayed to the customer.

User interface 700 includes information relating to the item, such as the name of the item, an item image, and a price, but without shipping options.

FIG. 7b shows an example user interface 701 displaying an inventory item 702a. The inventory item 702a is presented with a shipping option 704. In this example, one shipping option 704 is presented: two-day shipping. As determined by the transit time database 212, this item 702a can be delivered to the destination location 110 within two days. Therefore, two-day shipping is offered as an option to the customer. The online cart 706 displays two options for receiving the item 702a: two-day shipping (to the destination location 110) and shipping to a store 108. The online cart 706 is configured to receive a shipping option selection 708 from the customer.

In another example, not shown, two-day shipping would not be offered if the transit time database 212 determines that the item cannot be guaranteed to be delivered within two days. This is not to say that the item cannot be delivered within two days, but that such a delivery time is not guaranteed. Alternatively, the customer may need to pay extra for delivery within two days. In such an instance, a different shipping option may still be displayed, e.g., a five to seven day shipping option, or a paid, expedited two to three day shipping option may be presented.

Not presenting shipping options on a user interface 701 comprising a plurality of items 702 can reduce processing power. For example, the system 202 only needs to calculate transit times and determine the available shipping options for one item at a time, after the customer has selected the item to view. This may be important since shipping option availability is determined, in this instance, at the time the item is selected and user interface 701 is displayed.

Alternatively, FIG. 8 illustrates an alternative example user interface 800 that displays shipping options on a main page showing a plurality of items. The user interface 800 includes a list of a plurality of items 802 for sale. The second item listed for sale does not offer two-day shipping. The first and third item listed includes two-day shipping. The third item is selected 804, and shipping details are shown in the box. The third item has been selected 804 and shows additional shipping details in the shipping details box 806, allowing a customer to select which shipping option they desire. As shown, an option for pick-up at the retail location or two-day shipping are offered.

User interface 800 includes additional details relating to the item, including information relating to the items, such as the name of the item, an item image, an item rating, a price, and shipping information.

Presenting shipping options on a user interface 800 comprising a plurality of items 802 may require increased processing power, as the system 202 calculates transit times to determine shipping options for all items 802 offered for sale on user interface 800. However, this allows customers to browse a plurality of items 802 for sale and view shipping options without having to select an item to view more information.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method for determining an availability of a shipping option, the method comprising:
providing a retail user interface from an online retailer, the retail user interface including a plurality of selectable items available for delivery to a user;
receiving, at a software tool implemented on a computing system, inputs related to an order comprising an inventory item selected from among the plurality of selectable items;
determining, individually for the inventory item, one or more retail locations from which the inventory item can be delivered to a destination location within a predetermined time frame under default delivery conditions;
determining an actual transit time from each of the one or more retail locations to the destination location for the inventory item; and
based on the actual transit time from any of the one or more retail locations being below the predetermined time frame, automatically providing an item description web interface including a shipping option for delivery of the item within the predetermined time frame.

2. The method of claim 1, wherein the shipping option comprises a complimentary two-day shipping option.

3. The method of claim 1, wherein the predetermined time frame is less than or equal to two days.

4. The method of claim 1, wherein each of the plurality of selectable items in the retail user interface includes an item name and an item image, and lacks shipping availability information associated with the user.

5. The method of claim 1, wherein receiving inputs related to the order includes a destination location of the inventory item.

6. The method of claim 1, wherein the shipping option comprises an expedited shipping option.

7. The method of claim 1, wherein the one or more retail locations comprises a retail store location.

8. The method of claim 1, wherein the one or more retail locations includes a plurality of retail locations associated with a flow center.

9. The method of claim 1, wherein the actual transit time is based on current transit times determined, at least in part, from one or more of: weather conditions, natural disasters, road construction, and traffic delays identified within a transit time database.

10. The method of claim 9, wherein the transit times included in the transit time database include current and anticipated future transit times.

11. The method of claim 1, wherein default delivery conditions comprises economically feasible transit times.

12. A system for facilitating online orders fulfilled from retail locations, the system comprising:
a computing system comprising at least one processor communicatively connected to a memory, the memory storing computer-executable instructions comprising a software tool which, when executed, causes the computing system to:
provide a retail user interface from an online retailer, the retail user interface including a plurality of selectable items available for delivery to a user;
receive, at the software tool, inputs related to an order comprising an inventory item selected from among the plurality of selectable items;
determine, individually for the inventory item, one or more retail locations from which the inventory item can be delivered to a destination location of the user within a predetermined time frame under default delivery conditions;
determine an actual transit time from each of the one or more retail locations to the destination location for the inventory item;
based on the actual transit time from any of the one or more retail locations being below the predetermined time frame, automatically provide an item description web interface including a shipping option for delivery of the item within the predetermined time frame; and
based on the actual transit time from all of the one or more inventory locations being above the predetermined time frame, automatically provide the item description web interface including a second shipping option for delivery of the item within a second predetermined time frame, the second predetermined time frame being longer than the predetermined time frame.

13. The system of claim 12, wherein the second predetermined time frame is a time frame within which delivery of the item is possible from at least one of the one or more retail locations under the default delivery conditions.

14. The system of claim 12, wherein the computing system comprises a retail web server and a supply chain fulfillment server, and wherein the item description web interface is provided by the retail web server based on an input from the supply chain fulfillment server, the input indicating availability of the shipping option.

15. The system of claim 14, wherein one of the one or more retail locations is a retail location nearest the destination location.

16. The system of claim 14, further comprising a transit time database accessible via the supply chain fulfillment server, the transit time database storing the actual transit time, the actual transit time being based on current transit times determined, at least in part, from one or more of: weather conditions, natural disasters, road construction, and traffic delays.

17. The system of claim 14, wherein when the actual time is below the predetermined time frame, the shipping option comprises a complimentary two-day shipping option.

18. The system of claim 14, wherein receiving inputs related to the order includes a destination location of the inventory item.

19. A retail web server configured to facilitate online orders fulfilled from retail locations, the system comprising:
a computing system comprising at least one processor communicatively connected to a memory, the memory storing computer-executable instructions comprising a software tool which, when executed, causes the computing system to:
provide a retail user interface from an online retailer, the retail user interface including a plurality of selectable items available for delivery to a user;
receive, from a user device, a selection of an item from among the plurality of selectable items;
transmit the selection of the item and a delivery location to a supply chain fulfillment server;
receive, from a transit time database, a shipping time;
receive, from the supply chain fulfillment server, an indication of whether a shipping option for delivery of the item within the predetermined time frame is available based on current shipping conditions;
based on the shipping option being available, automatically providing an item user interface to the user device, the item user interface including an identification of the shipping option; and
based on the shipping option not being available, automatically providing the item user interface to the user device, the item user interface not including the identification of the shipping option.

20. The retail web server of claim 19, wherein the computing system is further configured to, based on the shipping option not being available, automatically provide the item user interface to the user device including a second shipping option different from the shipping option, the second shipping option being delayed relative to the shipping option and being based on the current shipping conditions.
